(19) United States
(12) Patent Application Publication
(10) Pub. No.: US 2012/0006627 A1
(43) Pub. Date: Jan. 12, 2012

(54) MONITORING OF SUPPORT IN AN ELEVATOR INSTALLATION

(76) Inventors: Donato Carparelli, Lugano-Pregasona (CH); Martin Rogger, Rotkreuz (CH); Francesco Tiani, Contone (CH); Alessandro D'Apice, Ebikon (CH)

(21) Appl. No.: 13/178,007

(22) Filed: Jul. 7, 2011

(30) Foreign Application Priority Data
Jul. 9, 2010 (EP) 10169119.4

(51) Int. Cl. B66B 5/12; B66B 1/34; B66B 11/08

(52) U.S. Cl. 187/266; 187/254; 187/391

(57) ABSTRACT

An elevator comprises an elevator car, a counterweight, a drive and a support, wherein the support couples the elevator car and the counterweight with the drive so that the elevator car and the counterweight are movable in opposite vertical directions by the drive, and wherein the support has a support section at the car side and a support section at the counterweight side. The elevator further comprises a sensor line which is coupled to both the elevator car and the counterweight and which is guided so that in the case of movement of the elevator car and the counterweight in opposite directions it generally remains tensioned by a substantially constant tension stress. The elevator further comprises a sensor which is coupled with the sensor line so that slackening of a support section is detectable by the sensor.

### CROSS-REFERENCE TO RELATED APPLICATION

This application claims priority to European Patent Application No. 10169119.4, filed Jul. 9, 2010, which is incorporated herein by reference.

### FIELD

The present disclosure relates to the monitoring of a support in an elevator installation.

### BACKGROUND

An elevator installation usually comprises an elevator car and at least one counterweight, which are moved in opposite directions in an elevator shaft. The elevator car and the at least one counterweight in this regard usually run in or along guide rails and are supported by at least one support means, which is guided over a driving drive pulley. The support means (also called “support”) usually consists of one or more sheathed steel cables, one or more synthetic fiber cables, one or more flat or profiled belts (wedge-ribbed belts) or a parallel-extending combination of the respectively mentioned embodiments, in which, for example, each individual support means can be guided over an individual drive pulley.

It is possible with such sheathed support means to realize such a high level of traction on the driving drive pulley that, for example, the elevator car can be raised further although the counterweight is obstructed in its downward movement by an unpredicted jamming in the elevator shaft or by an unpredicted seating on the shaft base buffers. The same problem can occur with the counterweight if the elevator car should sit on the shaft base buffers. This lifting of a load—be it the elevator car or the counterweight—at one side of the drive pulley without the intended counter-load conjunctively freely rising at the other side of the drive pulley can lead to dangerous conditions. Thus, a counterweight rising up or an elevator car rising up can drop back until the support means is stretched again to its entire length. An elevator car dropping back or a counterweight dropping back can significantly harm not only passengers, but also the elevator installation itself.

Consequently, monitoring devices for detection of an unloaded, slack support means have been developed. They are based, as disclosed in, for example, European published specification EP 1 953 108, on a spring-reinforced mounting of the entire drive and a deflecting unit with at least two further rollers for the support means. However, this solution has the disadvantage that it is connected with a high constructional cost and moreover does not make possible a reliable triggering value.

### SUMMARY

At least some embodiments disclosed herein enable monitoring of support means (also called “support”) in an elevator installation, which can be produced and installed economically and, moreover, can allow reliable detection of slack support means sections.

Particular embodiments comprise an elevator with an elevator car, a counterweight, a drive and a support means, wherein the support means couples the elevator car and the counterweight with the drive so that the elevator car and the counterweight are movable in opposite, generally vertical directions by the drive and wherein the support means has a support means section on the car side and a support means section on the counterweight side. The elevator additionally comprises a sensor line, which can be coupled with both the elevator car and the counterweight, and which is guided so that it remains tensioned by a substantially constant tension loading when the elevator car and the counterweight move in opposite directions. The elevator further comprises a sensor that can be coupled with the sensor line so that slackening of a support means section is detectable by the sensor. The sensor comprises a safety switch with a switch contact and a mechanical trigger, wherein in the case of slackening of a support means section the switch contact is deflected by the mechanical trigger so that the slackening of a support means section is detectable by the safety switch.

In some embodiments, movement of the mechanical trigger relative to the switch contact is limited by mechanical abutments. It is thereby possible to prevent the safety switch or the switch contact or the mechanical trigger being damaged in the case of a strong change in tension of the sensor line.

In other embodiments the elevator further comprises a control device, which is configured so that the drive is not freed when the sensor detects, via the connecting element, a slack support means section.

Some embodiments comprise a method for increasing operational reliability of an elevator. A sensor line is again coupled to the elevator car and the counterweight so that in the case of a uniform movement of the elevator car and the counterweight in opposite, generally vertical directions the sensor line remains tensioned by a substantially constant tension loading. A sensor, which is coupled to the sensor line, monitors in one step of the method, wherein slackening of a support means section is detected by the sensor.

In a further embodiment a drive of the elevator is controlled in a further step, wherein the drive is not freed if the sensor detects, by way of the sensor line, slackening of a support means section.

The sensor line is a flexible, elongated element and can have, for example, the form of a cable, band or belt. It can be light and has a very small capability of stretching in length. A cable of Kevlar, for example, can be used as sensor line. In an embodiment a weight of the sensor line is less than 10 kg/100 m, possibly less than 5 kg/100 m, possibly less than 1 kg/100 m. In a further exemplifying embodiment a diameter of the sensor line is less than 2 cm, possibly less than 1 cm, possibly less than 0.5 cm.

The sensor can be coupled with the sensor line. In that case the sensor can be arranged directly at the elevator car or at the counterweight or, however, at a location of the sensor line between the elevator car and counterweight. In an alternative embodiment the sensor is coupled with the sensor line by way of an additional element, for example by way of a deflecting roller.

Monitoring of the support means by an additional sensor line and a sensor coupled thereto can have the advantage that such a monitoring system can also be incorporated into existing elevator installations. In addition, adaptations to other components of the elevator installation such as, for example, the drive are not necessary.

Moreover, in at least some embodiments, the monitoring device described here can be realized economically. For example, both the sensor line and the sensor itself can be constructed from advantageous components.

In at least some cases, due to the fact that the sensor line and the sensor can function independently of other elevator components, a reliable detection of slack support means sections can be achieved.

### BRIEF DESCRIPTION OF THE DRAWINGS

The disclosed technologies are explained symbolically and by way of example on the basis of figures, in which:

FIG. 1 shows an illustration, by way of example, of an elevator in which a counterweight stands on a buffer and an elevator cage is raised further by a drive so that a support means section on the counterweight side slackens;

FIG. 2 shows an illustration, by way of example, of an elevator with a sensor line and a sensor;

FIG. 3 shows an illustration, by way of example, of an elevator with a sensor line and a sensor;

FIG. 4a shows an illustration, by way of example, of a deflecting roller for a sensor line;

FIG. 4b shows an illustration, by way of example, of a sensor at a deflecting roller;

FIG. 4c shows an illustration, by way of example, of a sensor at a deflecting roller;

FIG. 5a shows an illustration, by way of example, of a sensor which is coupled with a sensor line;

FIG. 5b shows an illustration, by way of example, of a sensor which is coupled with a sensor line;

FIG. 6a shows an illustration, by way of example, of a sensor at a deflecting roller; and

FIG. 6b shows an illustration, by way of example, of a sensor at a deflecting roller.

### DETAILED DESCRIPTION

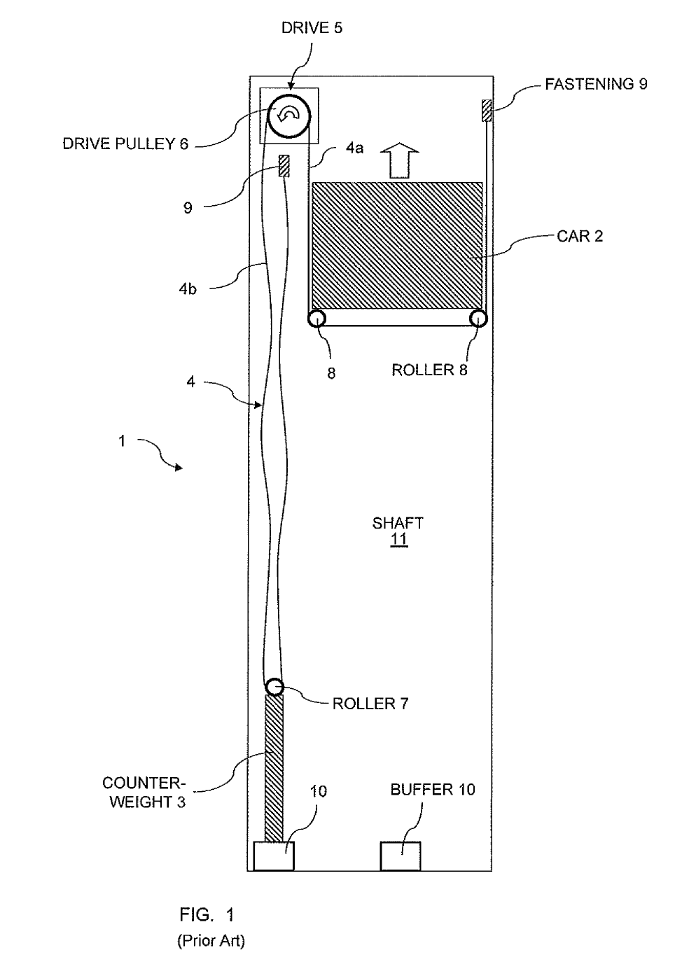

FIG. 1 shows an elevator 1 with an elevator car 2, a counterweight 3, a drive 5 and a support means 4. The support means 4 couples the elevator car 2 and the counterweight 3 with the drive 5 so that the elevator car 2 and the counterweight 3 are movable in vertical direction in opposite sense by the drive 5. The drive 5 has a drive pulley 6 over which the support means 4 is guided. The support means 4 is, in addition, fixed at the ends thereof to support means fastenings 9 in the elevator shaft 11. The support means 4 has a support means section 4a on the cage side and a support means section 4b on the counterweight side. The support means section 4a on the car side extends from the drive pulley 6 via car support rollers 8 to the support means fastening 9 on the car side. The support means section 4b on the counterweight side extends from the drive pulley 6 via a counterweight support roller 7 to a support means fastening 9 on the counterweight side. The lengths of the support means sections 4a, 4b on the car side and the counterweight side vary when the elevator car and the counterweight are moved.

In order to damp a possible impact of the elevator car 2 or the counterweight 3 on the base of the elevator shaft 11, buffers 10 are respectively provided under the elevator car 2 and under the counterweight 3. As illustrated in FIG. 1, it can happen that due to a fault in the elevator control the counterweight 3 seats on the buffer 10. If the drive 5 in such a situation remains active as illustrated in FIG. 1 and drives the elevator car 2 further upwardly, the support means 4b at the counterweight side slackens. In an embodiment which is not illustrated, the elevator car 2 seats on the buffer 10 and the drive 5 drives the counterweight 3 further upwardly so that the support means section 4a slackens. Such a lifting up of the elevator car 2 or the counterweight 3 without the counterweight 3 or the elevator car 2 then dropping to the same extent is, however, usually possible only if the traction between the drive pulley 6 and the support means 4 is correspondingly high.

The monitoring device described here has the advantage that it can detect slackening of a support means section 4a, 4b directly so that it can be possible to largely avoid creation of the dangerous situation in which the elevator car 2 or the counterweight 3 is raised without the counterweight 3 or the elevator car 2 in that case dropping to the same extent. A monitoring device for the support means 4, which can detect slackening of a support means section 4a, 4b, is now described in more detail on the basis of the following figures.

FIG. 2 shows an exemplifying elevator installation 1 as was explained in more detail in FIG. 1. For monitoring of the support means 4, here a sensor line 12 and a sensor 14 according to an exemplary embodiment are arranged. The sensor line 12 is coupled to the elevator car 2 and the counterweight 3. In addition, the sensor line 12 is guided over two deflecting rollers 13. The deflecting rollers 13 are arranged in such a manner that the sensor line 12 is guided substantially vertically downward not only from the counterweight 3, but also from the elevator car 2. It can be achieved by such a guidance of the sensor line 12 that the sensor line 12 in the case of movement of the elevator car 2 and the counterweight 3 in opposite directions remains tensioned by a substantially constant tension loading.

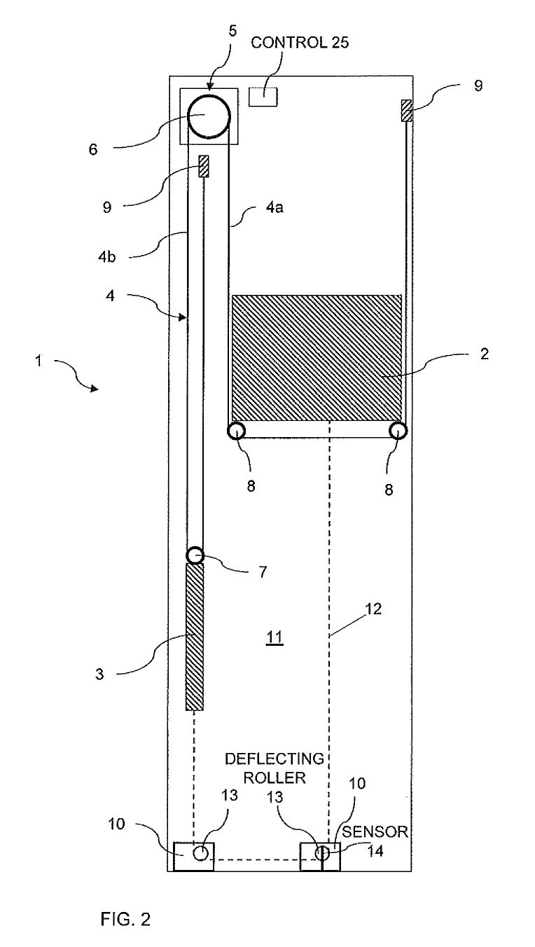

In this exemplary embodiment a sensor 14 is arranged at one of the deflecting rollers. As shown in FIG. 3, the sensor 14 can also be coupled with the sensor line 12 in a different manner.

In the exemplary embodiment illustrated in FIG. 2 the deflecting rollers 13 are arranged at the buffers 10. In further embodiments the deflecting rollers 13 are arranged at a shaft wall, a shaft base or another element of the elevator 1. In addition, it is also possible to guide the sensor line 12 by only one deflecting roller or by other devices. In that case it can be significant that the sensor line 12 in the case of movement of the elevator car 2 and the counterweight 3 in opposite directions remains tensioned by a substantially constant tension loading.

A control device 25 can be configured in such a manner that the drive 5 is not freed when the sensor 14 detects, via the connecting element 12, a slack support means section 4a, 4b. The control device 25 can in that case be integrated in an elevator control or constructed as a separate control device. A potential advantage of the monitoring device described here can be that the control device can be switched off immediately as soon as the sensor 14 has detected a slack support means section 4a, 4b. It is thereby possible to prevent occurrence of a risky situation in which the elevator car 2 or the counterweight 3 could possibly fall back due to a slack support means section 4a or 4b.

In the exemplary embodiment of FIG. 2, the sensor line 12 is arranged in each instance below the elevator car 2 and the counterweight 3. As illustrated in FIG. 3, the sensor line 12 can also be arranged above the elevator car 2 and the counterweight 3. A further difference between the exemplary embodiments of FIGS. 2 and 3 consists in the fact that the sensor 14 in FIG. 2 is triggered by a tension loading of the sensor line 12, whereas the sensor 14 in FIG. 3 is triggered by relief of the loading of the sensor line 12.

In FIG. 3 the sensor line 12 is similarly guided over two deflecting rollers 13. In this exemplary embodiment the sensor 14 is not, however, arranged at a deflecting roller 13, but at an end of the sensor line 12. In the illustrated exemplary embodiment the sensor 14 is arranged at the counterweight 3. In an alternative embodiment the sensor 14 is arranged at the elevator car 2. Exemplary embodiments of the sensor 14 are explained in more detail on the basis of the following figures.

The various embodiments of the sensor 14 can be used not only in the case of guidance of the sensor line 12 above the car and the counterweight, but also in the case of guidance of the sensor line 12 below the elevator car 2 and the counterweight 3. In that case, however, it is to be noted that a sensor 14 for the embodiment in FIG. 3 is activated in a case of relief of loading of the sensor line 12 and that the sensor 14 from the exemplary embodiment in FIG. 2 is activated when tension loading of the sensor line 12 occurs.

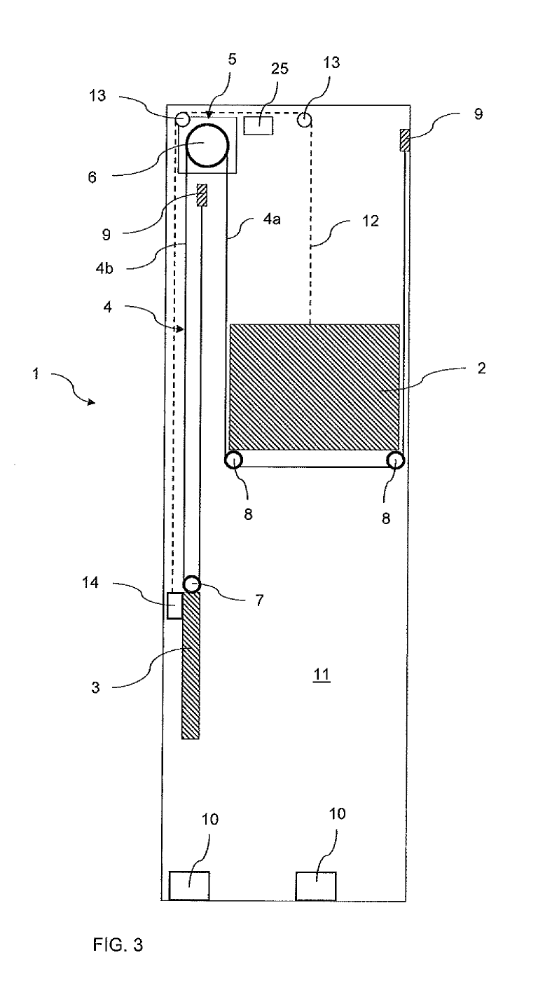

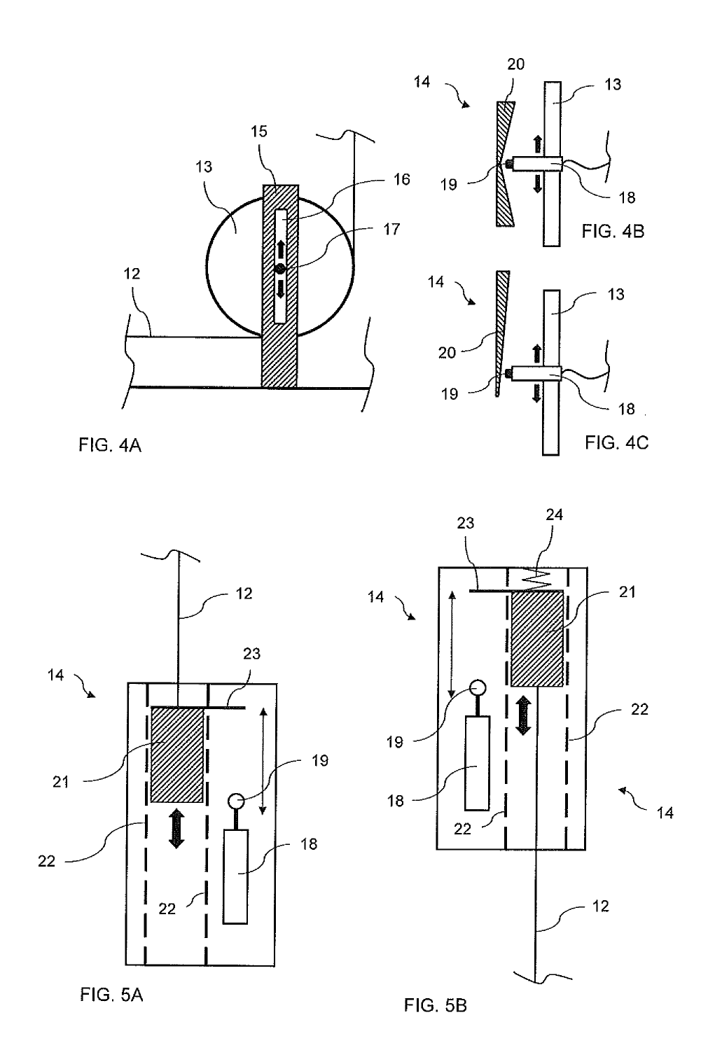

FIG. 4a shows a deflecting roller 13 for guidance of the sensor line 12. The deflecting roller 13 has a guide pin 17 arranged in a center of rotation of the deflecting roller 13. This guide pin 17 is guided in a guide slot 16 of a deflecting roller guide 15. A vertical length of the guide slot 16 in that case defines a play of the deflecting roller 13, e.g., a maximum play.

A sensor 14, which can be arranged at a deflecting roller 13, is illustrated in FIG. 4b. In that case, a safety switch 18 with a switch contact 19 is arranged at a center of rotation of the deflecting roller 13. A mechanical trigger in the form of a switch profile 20 is now arranged such that the switch contact 19 is actuated by the switch profile 20 when the safety switch 18 and therewith the deflecting roller 13 displace relative to the switch profile 20 within a predefined range. The switch profile 20 illustrated in FIG. 4b can be so constructed that the safety switch 18 is activated not only in the case of upward movement, but also in the case of downward movement of the deflecting roller 13.

An embodiment of a sensor 14 for monitoring a deflecting roller 13 is similarly illustrated in FIG. 4c. By contrast to the sensor in FIG. 4b this sensor 14 is activated only in the case of upward movement of the deflecting roller 13. In various embodiments, the switch profile 20 can be adapted to the respective requirements. A shaping of the switch profile 20 can also define a play in which the deflecting roller 13 is indeed moved, but the switch contact 19 is not activated. This can help prevent activation of the sensor 14 when the sensor line 12 in the case of movement of the elevator car 2 or the counterweight 3 swings and in that case slightly deflects the deflecting roller 13.

A further embodiment of a sensor 14 is illustrated in FIG. 5a. This type of sensor 14 is suitable for, for example, arrangement at the counterweight 3 or at the elevator car 2. A trigger weight 21 is arranged in the sensor 14. This trigger weight 21 is coupled with the sensor line 12. The trigger weight 21 is guided by guides 22 in the sensor 14. The trigger weight 21 can move, up and down within the sensor 14, along the guides 22. A mechanical trigger in the form of a trigger beam 23 is coupled to the trigger weight 21. A safety switch 18 with a switch contact 19 is so arranged in the sensor 14 that the trigger beam activates the switch contact 19 in the case of a predefined movement of the trigger weight 21. As in the case of the sensor 14 in FIGS. 4b and 4c, a certain degree of movement play of the compensating weight 21 can (in some embodiments) be made possible here without the safety switch 18 being activated. This play can be matched to the respective characteristic of the sensor line 12 and the dimensions of the elevator 1.

The sensor 14 in FIG. 5a can be suitable for, for example guidance of the sensor line 12 as is illustrated in FIG. 3.

The sensor 14 illustrated in FIG. 5b substantially corresponds with that of FIG. 5a. The difference is that the sensor 14 of FIG. 5b can be activated by loading of the sensor line 12, whereas the sensor 14 of FIG. 5a can be activated by relief of loading of the sensor line 12. The sensor 14 of FIG. 5b can thus be used in, for example, an elevator installation like that of FIG. 2. In order to prevent activation of the safety switch 18 in a normal state, a spring 24 is arranged at the trigger weight 21. Generally, only if the sensor line 12 is loaded to a sufficient degree is the trigger weight 21 drawn downwardly, notwithstanding the spring restoring force of the spring 24, so that in the case of a sufficient degree of loading of the sensor line 12 the safety switch 18 is activated by actuation of the switch contact 19 via the trigger beam 23.

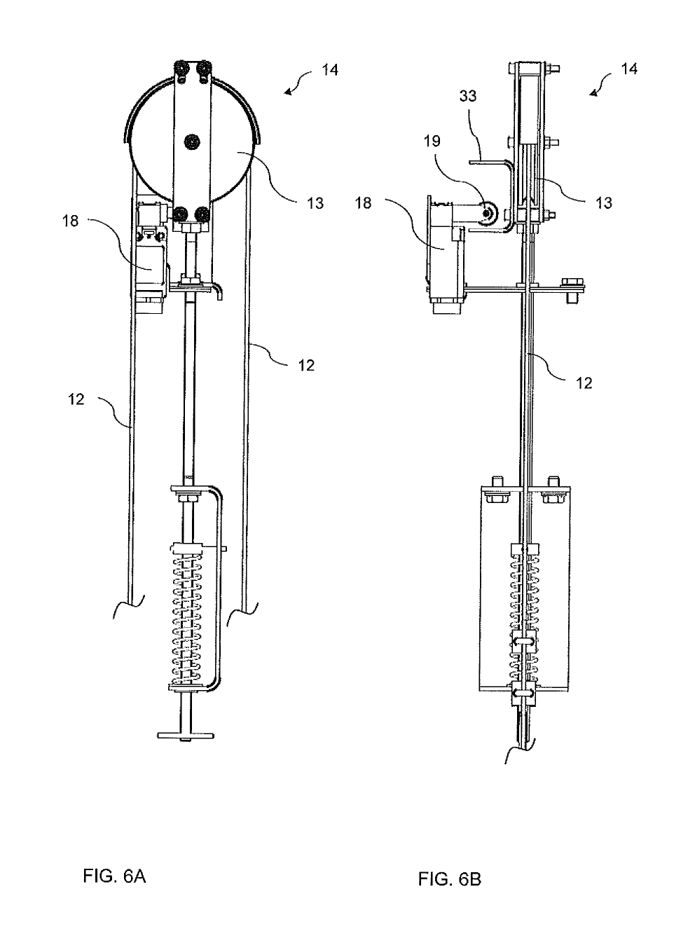

A further exemplifying form of embodiment of a sensor for recognition of a slack support means section is illustrated in FIGS. 6a and 6b. In that case FIG. 6a shows a front view and FIG. 6b a side view of the same form of embodiment. The deflecting roller 13 is here mounted under bias by a spring so that tensioning of the sensor line 12 and biasing of the spring maintain equilibrium. If, now, tension of the sensor line 12 changes, then the deflecting roller 13 displaces together with the mechanical trigger 33 downwardly or upwardly depending whether the tensioning of the sensor line 12 increases or reduces. The switch contact 19 and the safety switch 18 are not in that case deflected, so that the mechanical trigger 33 displaces relative to the switch contact 19. If this displacement is of sufficient magnitude then the switch contact 19 is deflected by the mechanical trigger 33 and the safety switch 18 is switched over.

In various embodiments, the sensor illustrated in FIGS. 6a and 6b can be arranged above or below the elevator car or the counterweight. Through use of the spring for balancing the tensioning of the sensor line 12, compensation can be provided for the gravitational force effect of the deflecting roller 13 depending on how the sensor is orientated (e.g., below or above the elevator car or the counterweight).

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator, comprising:
an elevator car;
a counterweight;
a support, the support being coupled to the elevator car and the counterweight, the support comprising a car-side section and a counterweight-side section;
a sensor line coupled to the elevator car and the counterweight, the sensor line being configured to be subject to a substantially constant loading tension during movements of the elevator car and the counterweight; and
a sensor coupled to the sensor line, the sensor comprising a safety switch with a switch contact and a mechanical trigger, the mechanical trigger being configured to contact the switch contact upon slackening of the car-side section of the support or the counterweight-side section of the support.

2. The elevator of claim 1, further comprising a control device and a drive, the control device being configured to not free the drive as a result of a signal from the sensor coupled to the sensor line.

3. The elevator of claim 1, further comprising at least one deflecting roller, the sensor line being guided by the at least one deflecting roller.

4. The elevator of claim 3, the at least one deflecting roller comprising first and second deflecting rollers, the sensor line being guided from the elevator car substantially in a travel direction of the elevator car to the first deflecting roller and then to the second deflecting roller, and from the second deflecting roller to the counterweight substantially in a travel direction of the counterweight.

5. The elevator of claim 3, the at least one deflecting roller comprising first and second deflecting rollers, the first deflecting roller being arranged below the elevator car and the second deflecting roller being arranged below the counterweight.

6. The elevator of claim 3, the at least one deflecting roller comprising first and second deflecting rollers, the first deflecting roller being arranged above the elevator car and the second deflecting roller being arranged above the counterweight.

7. The elevator of claim 3, the sensor being coupled with the at least one deflecting roller.

8. The elevator of claim 7, the deflecting roller comprising a guide pin arranged in a center of rotation of the deflecting roller, the guide pin being positioned in a guide slot of a deflecting roller guide.

9. The elevator of claim 8, the switch contact being arranged at the deflecting roller, the mechanical trigger being configured to depress the switch contact in response to displacement of the deflecting roller in the deflecting roller guide.

10. The elevator of claim 1, the sensor being arranged at the elevator care or at the counterweight.

11. The elevator of claim 10, further comprising a trigger weight fastened to the sensor line, the trigger weight being configured to move relative to the sensor and activate the safety switch.

12. The elevator of claim 11, the sensor comprising one or more interior guides for the trigger weight.

13. The elevator of claim 1, the sensor line comprising a synthetic fiber cable having a diameter less than 0.5 centimeters.

14. The elevator of claim 1, the sensor line having a weight of less than 1 kg/100 m.

15. The elevator of claim 1, a movement of the mechanical trigger relative to the switch contact being limited by one or more mechanical abutments.

16. An elevator installation, comprising:
an elevator car disposed in an elevator shaft;
a counterweight disposed in the elevator shaft;
a support means, the support means being coupled to the elevator car and the counterweight;
a sensor line coupled to the elevator car and the counterweight, the sensor line being subject to a loading tension during at least some movements of the elevator car and the counterweight; and
a sensor coupled to the sensor line, the sensor comprising a safety switch with a switch contact and a mechanical trigger, the mechanical trigger being configured to contact the switch contact upon slackening of a portion of the support means.

17. An elevator sensor system, comprising:
a sensor line configured to be coupled to an elevator car and a counterweight, the sensor line being configured to be subject to a loading tension during at least some movements of the elevator car and the counterweight within an elevator shaft; and
a sensor coupled to the sensor line, the sensor comprising a safety switch with a switch contact and a mechanical trigger, the mechanical trigger being configured to contact the switch contact upon slackening of a portion of a support, the support coupling the elevator car and the counterweight.
